(19) United States
(12) Patent Application Publication
(10) Pub. No.: US 2006/0000754 A1
(43) Pub. Date: Jan. 5, 2006

(54) Water shut-off device for a water purifier

(76) Inventors: Won-Seok Kang, Seoul (KR); Keun-Won Lim, Daejeon (KR)

Correspondence Address: BROUSE MCDOWELL LPA, 388 SOUTH MAIN STREET, SUITE 500, AKRON, OH, 44311, US

(21) Appl. No.: 10/529,562

(22) PCT Filed: Oct. 31, 2003
(86) PCT No.: PCT/KR03/02316

§ 371 Date: Mar. 28, 2005

(30) Foreign Application Priority Data
Nov. 8, 2002 (KR) 10-2002-0069304

(51) Int. Cl. B01D 33/70

(52) U.S. Cl. 210/97; 210/234; 210/235

(57) ABSTRACT

A water shut-off device for a water purifier that assures automatic blocking of water flow at the time of changing of a used filter comprises a connector having a water inlet passageway and a first connector port in communication with the inlet passageway, the first connector port provided with a valve chamber. A valve body is movably fitted into the valve chamber for selectively closing and opening the first connector port. Removably coupled to the connector is a filter which has an inlet port connectable to the first connector port of the connector, a filter element, an outlet port and a pusher for, when the inlet port is brought into connection with the first connector port, causing the valve body to move into a position wherein the first connector port is opened to allow water flow.

This application claims priority from PCT patent application PCT/KR2003/002316 with an International filing date of Oct. 31, 2003, which claims priority from Korean Patent Application No. 10-2002-0069364, filed Nov. 8, 2002.

### I. BACKGROUND OF THE INVENTION

A. Field of the Invetion

The present invention is directed to a water shut-off device for a water purifier and, more specifically, to a water shut-off device for a water purifier that can effectively block the flow of raw water at the time of changing of a used filter.

B. Description of the Related Art

Due to water pollution, the tap water supplied to every home or office could hardly be drunk as it is. There is a growing need for a water purifier that can purify polluted water (hereinafter, referred to as “raw water”) into clean water suitable for drinking (hereinafter, referred to as “purified water”).

The conventional water purifiers are provided with a plurality of filters for filtering the raw water. Each of the filters comprises a cylindrical casing, a filtering element disposed inside of the casing, an inlet port for introducing the raw water and an outlet port through which the filtered water is discharged. The filters are connected in series with each other so that the polluted raw water can consecutively pass through the filters and finally converted into clean purified water.

In the meantime, according to the conventional water purifiers, there is a need to periodically change the filters depending on the polluted condition of the filters. In the process of detaching the filters from the connector for replacement with new ones, an appropriate measure must be taken to prohibit the introduction of the raw water, which process is highly inconvenient to perform. The raw water will be leaked from the connector if the filters are removed from the connector without blocking the introduction of the raw water. In order to block the flow of the raw water, the water purifier should be provided with an electromagnetic or manual shut-off valve that is costly to purchase.

### II. SUMMARY OF THE INVENTION

Accordingly, it is an object of the present invention is to provide a water shut-off device for a water purifier that can effectively block the flow of raw water and prohibit the water from leakage when filters are removed from a connector for replacement with new ones.

Another object of the invention is to provide a water shut-off device for a water purifier that makes it possible to cut off the water flow in a simple and cost-effective manner, thereby reducing the manufacturing cost of the water purifier.

In order to achieve the above objects, the present invention provides a water shut-off device for a water purifier adapted to automatically cut off the flow of raw water at the time of filter replacement, comprising: a connector having a water inlet passageway and a first connector port in communication with the inlet passageway, said first connector port provided with a valve chamber; a valve body movably fitted into the valve chamber for closing the first connector port when the filter is detached from the connector and for opening the first connector port when the filter is attached to the connector; and a filter means detachably attached to the connector, said filter means having an inlet port connectable to the first connector port of the connector, a filter element, an outlet port, and a pusher for causing the valve body to move into a position in which the first connector port is opened, when the inlet port is brought into connection with the first connector port.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a cross-sectional view showing a water shut-off device for a water purifier according to the present invention.

FIG. 2 is a sectional view taken along line II-II in FIG. 1.

FIG. 3 is a sectional view taken along line III-III in FIG. 1.

FIG. 4 is a sectional view taken along line IV-IV in FIG. 1.

FIGS. 5 through 7 illustrate water shut-off devices for a water purifier according to other embodiments of the present invention.

### IV. DESCRIPTION OF THE PREFERRED EMBODIMENT

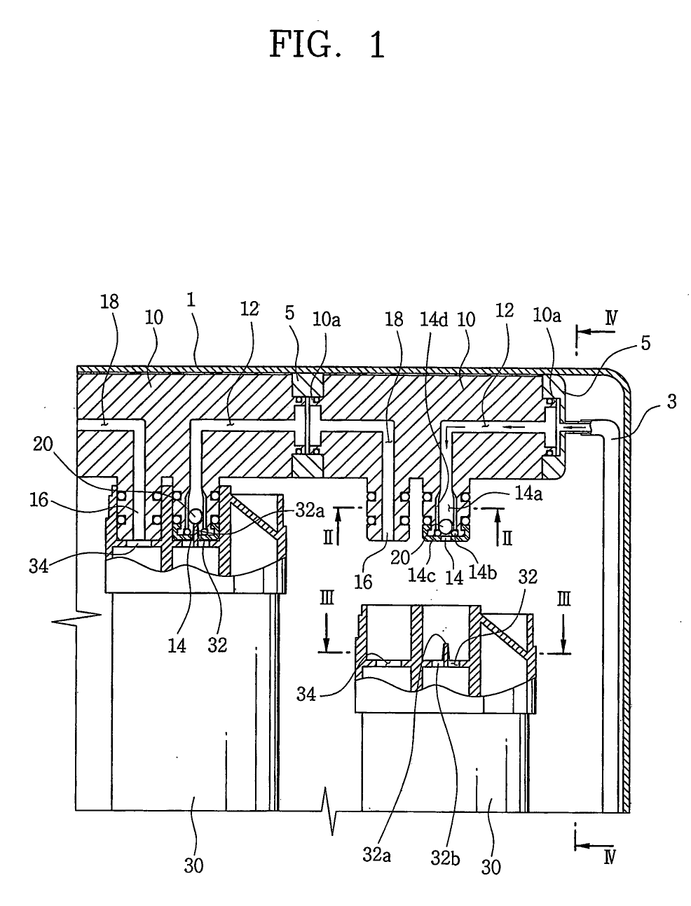

Referring now to the drawings wherein the showings are for purposes of illustrating a preferred embodiment of the invention only and not for purposes of limiting the same, FIGS. 1-7 show the present invention.

Referring to FIG. 1, there is shown a sectional view of a water shut-off device for a water purifier in accordance with the invention. The water shut-off device comprises a connector 10 mounted to a housing 1 of a water purifier and a filter 30 removably attached to the connector 10. The connector 10 is provided with a water inlet passageway 12 and a first connector port 14 in communication with the inlet passageway 12. The water inlet passageway 12 is coupled to, and receives raw water from, an introduction conduit 3, which in turn is connected to a water source. The first connector port 14 is connected to an inlet port 32 of the filter 30 and serves to transfer the raw water in the water inlet passageway 12 to the inlet port 32 of the filter 30.

The connector 10 is further provided with a second connector port 16 and a purified water discharge passageway 18 in communication with the second connector port 16. The second connector port 16 is connected to an outlet port 34 of the filter 30 so that it can receive the purified water discharged from the outlet port 34 of the filter 30. The purified water discharge passageway 18 is adapted to communicate with a water inlet passageway 12 of another adjoining connector 10 and constructed to transfer the purified water to the adjoining connector 10.

In the meantime, the first connector port 14 of the connector 14 has a valve chamber 14a, which is provided with a valve seat 14b. The valve seat 14a is comprised of a rubber O-ring that remains secured to the first connector port 14 by means of a retainer 14c. Disposed in the valve chamber 14a is a valve body 20, e.g., in the configuration of a ball, which can make abutment with the valve seat 14b by the pressure of the raw water introduced into the valve chamber 14a through the water inlet passageway 12, thereby closing the first connector port 14 in the same manner as a typical check valve does.

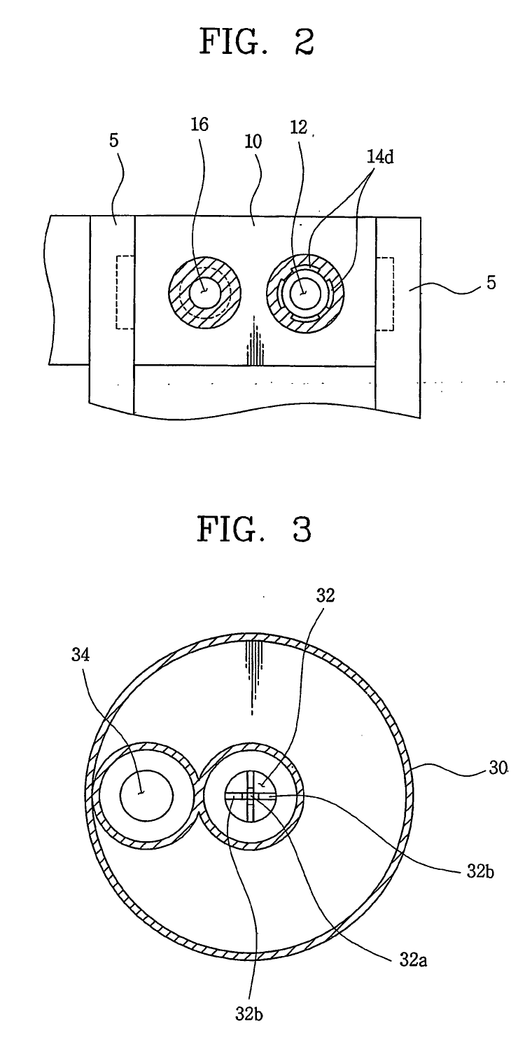

Such abutment of the valve body 20 with the valve seat 14b and the resultant closing of the first connector port 14 will cut off the flow of the raw water in the event that the filter 30 is removed from the connector 10 for replacement with a new one. This lessens the inconvenience, which would otherwise be encountered in the prior art water purifiers that requires use of a separate shut-off valve to avoid water leakage in the process of replacing the filter 30. The valve body 20 has to be movable in the valve chamber 14a, meaning that appropriate spacing should be left between the valve body 20 and the inner surface of the valve chamber 14a. Leaving the spacing in this manner allows the raw water introduced into the valve chamber 14a to be discharged through the first connector port 14, when the valve body 14a is spaced apart from the valve seat 14b. A plurality of water flow grooves 14d are provided on the inner circumference of the valve chamber 14a, as illustrated in FIG. 2.

Referring again to FIG. 1, it can be appreciated that the water shut-off device comprises the filter 30, as an essential element, which includes a filtering element (not shown) that can purify the raw water. As set forth earlier, the filter 30 is provided with the inlet port 32 and the outlet port 34. The inlet port 32 is connected to the first connector port 14 of the connector 10 and introduces the raw water from the first connector port 14. The outlet port 34 is coupled to the second connector port 16 of the connector 10 and serves to discharge the purified water to the second connector port 16.

The filter 30 is provided at the inlet port 32 with a pusher 32a that projects outwardly. The pusher 32a is inserted through the first connector port 14 of the connector 10 and pushes the valve body 20 as the inlet port 32 of the filter 30 is connected to the first connector port 14 of the connector 10.

The pusher 32a of this construction serves to open the first connector port 14 by way of pushing the valve body 20 away from the valve seat 14b. Such pushing and opening movement occurs simultaneously with the attachment of the filter 30 to the connector 10, thus making it possible to introduce the raw water into the filter 30 without having to operate any separate valve. It is a matter of course that the pusher 32a has a diameter far smaller than the inner diameter of the first connector port 14 and, as shown in FIG. 3, is supported by a plurality of ribs 32b in the inlet port 32.

The inventive water shut-off device noted above ensures that, when the filter 30 is removed from the connector 10, the valve body 20 can close the first connector port 14 of the connector 10 under the pressure of the raw water, thereby automatically cutting off the flow of the raw water. To the contrary, when the filter 30 is attached to the connector 10, the pusher 32a of the filter 30 will cause the valve body 20 to move in such a manner that the first connector port 14 of the connector 10 can be opened.

In a nutshell, according to the inventive water shut-off device, the flow of the raw water is automatically cut off and then resumed in the course of removing the filter 30 from the connector 10 and attaching a new filter to the connector 10, assuring easier and convenient replacement of the filter 30 used.

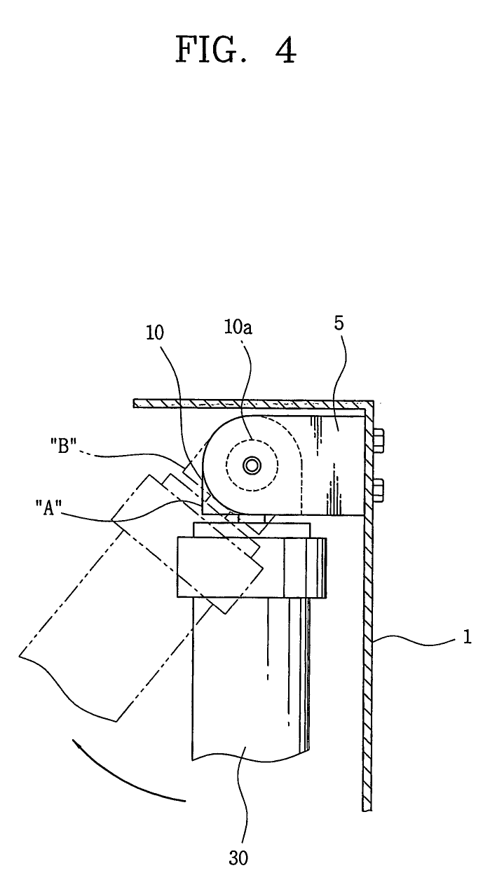

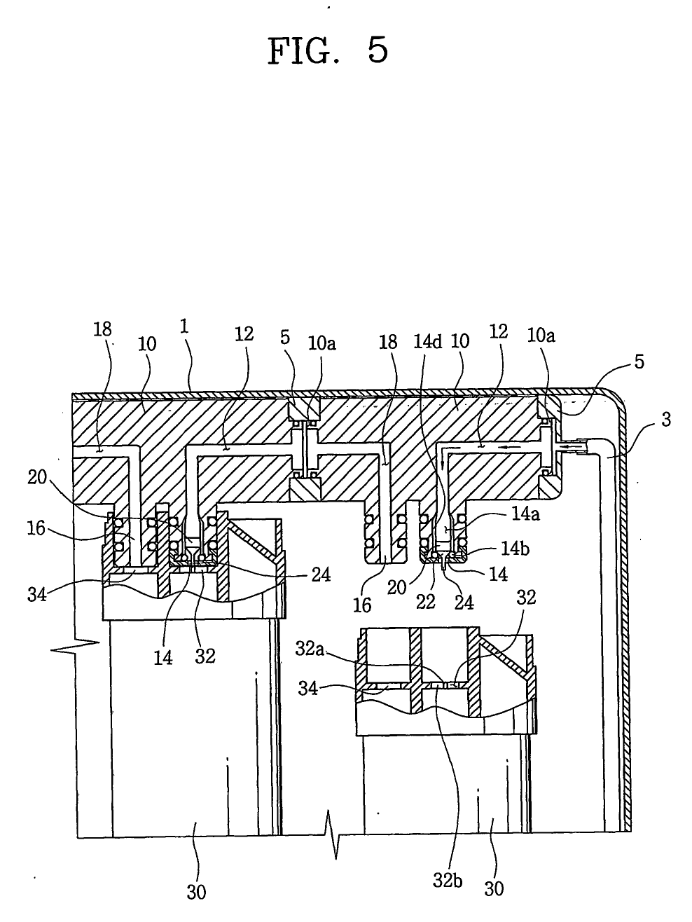

As illustrated in FIG. 1, the connector 10 employed in the present invention is mounted to the housing 1 of the water purifier by way of rotatably joining the pivot axis 10a with a support bracket 5. Therefore, the connector 10 is swingable about the pivot axis 10a between a filter use position (A) and a filter replacement position (B) with respect to the housing 1 of the water purifier, as shown in FIG. 4. This helps assure easier replacement of the filter 30.

Referring to FIGS. 5 through 7, there are shown other embodiments of the present invention. In the embodiment illustrated in FIG. 5, a poppet is used as the valve body 20 for closing the first connector port 14 of the connector 10. The poppet 20 is provided with a tapering poppet face 22 contactable with the valve seat 14b and a rod 24 projecting outwardly through the first connector port 14. The poppet face 22 is adapted to make abutment with the valve seat 14b to thereby close the first connector port 14. And, the projecting rod 24 is adapted to be depressed by the pusher 32a of the filter 30. As the projecting rod 24 is depressed by the pusher 32a, the poppet 20 is caused to move away from the valve seat 14b so that the first connector port 14 can be opened accordingly.

By way of using the poppet as the valve body 20 for closing the first valve port 14, it becomes possible to maximize the contact area of the poppet with the valve seat 14b, thus increasing the efficiency of closing the first connector port 14. In case of using the poppet as the valve body 20 in this embodiment, there is no need to employ the rubber O-ring to construct the valve seat 14b. This is because the poppet face 22 of the poppet 20 will make contact with the valve seat 14b at the area great enough to close the first connector port 14. If the poppet 20 is made of elastically deformable material, e.g., soft plastic or metal, the first connector port 14 will be positively closed without having to use an additional sealing material such as the O-ring 14b. Furthermore, using the poppet as the valve body 20 ensures that the pusher 32a of the filter 30 for depressing the projecting rod 24 of the poppet 20 can be shortened in length. This is due to the fact that the projecting rod 24 of the poppet 20 extends to the outside through the first connector port 14, allowing the pusher 32a of short length to push the projecting rod 24 with sufficient forces.

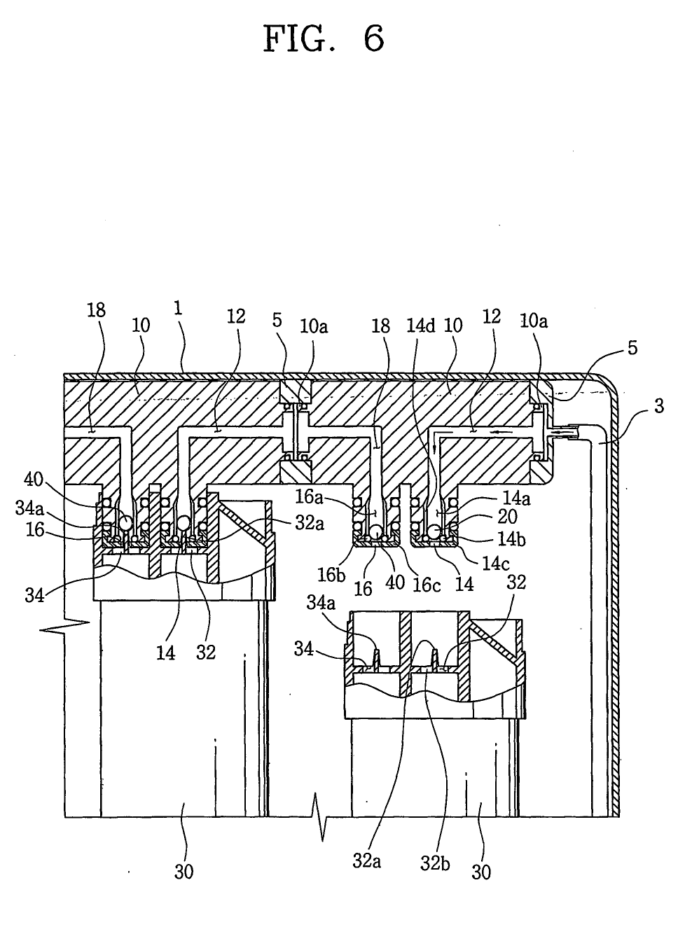

Turning to the embodiment shown in FIG. 6, a valve chamber 16a with a valve seat 16b is provided in the second connector port 16 of the connector 10. A valve body 40 for closing the second connector port 16 is disposed in the valve chamber 16a. A pusher 34a for pushing the valve body 40 is provided in the outlet port 34 of the filter 30 connected to the second connector port 16.

According to this embodiment, the valve body 40 disposed in the second connector port 16 acts as a conventional check valve to close the second connector port 16. This helps avoid backflow of the water from the purified water discharge passageway 18 when the filter 30 is removed from the connector 10 for replacement. Moreover, the pusher 34a provided in the outlet port 34 of the filter 30 will push the valve body 40 to open the second connector port 16 as the filter 30 is re-attached to the connector 10.

Eventually, with the arrangement in this embodiment, backflow of the water out of the purified water discharge passageway 18 is positively prohibited even if the filter 30 is removed from the connector 10, thus avoiding any leakage of the water in the course of filter replacement.

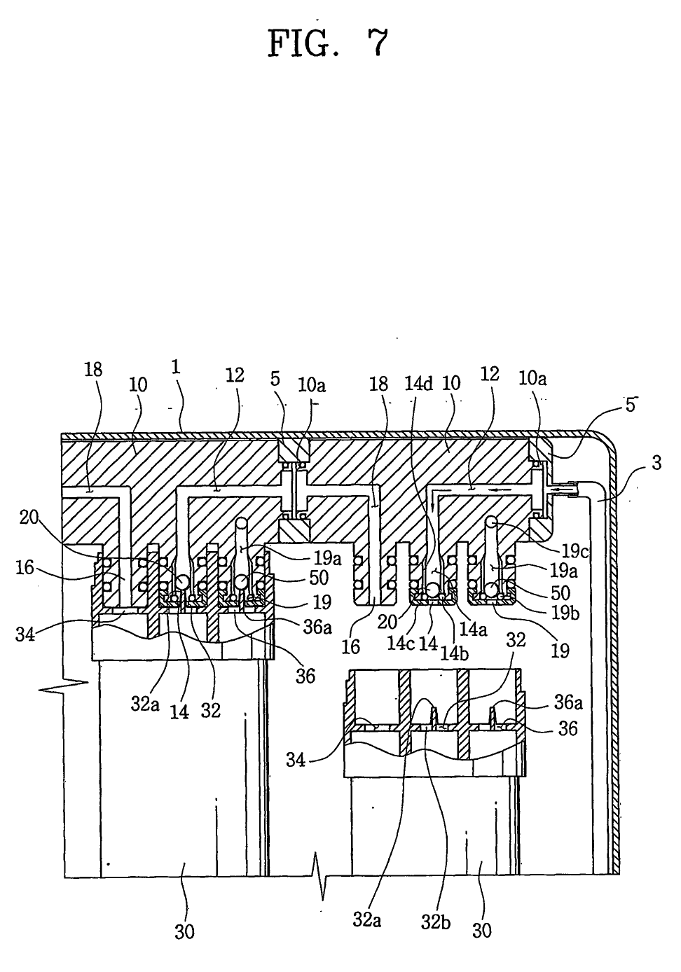

Referring finally to FIG. 7, which shows a further embodiment of the present invention, a third connector port 19 is formed in the connector 10 and a valve chamber 19a with a valve seat 19b is provided in the third connector port 19. A valve body 50 for closing the third connector port 19 is disposed in the valve chamber 19a. In addition, formed in the filter 30 is an auxiliary outlet port 36 that is connected to the third connector port 19 of the connector 10. A pusher 36a for pushing the valve body 50 of the third connector port 19 is provided in the auxiliary outlet port 36. It should be appreciated that the auxiliary outlet port 36 of the filter 30 is to discharge the water from a reverse osmosis filter element, in case of a reverse osmosis type filter being used. The auxiliary outlet port 36 is in communication with the third connector port 19.

According to this embodiment, the valve body 50 disposed in the third connector port 19 can act like a conventional check valve to close the third connector port 19 and cut off the backflow of the water from the auxiliary outlet port 36, when the filter 30 is removed from the connector 10 for replacement. In this fashion, water leakage from the third connector port 19 is avoided in the process of filter replacement.

As described hereinabove, the inventive water shut-off device can automatically cut off the water flow, when the filter 30 is removed from the connector 10 of the water purifier housing 1, and allow the water flow to be automatically resumed, when the filter 30 is attached to the connector 10, thus assuring easier replacement of the filter 30.

In the embodiments illustrated in the drawings, the valve chambers 14a, 16a, 19a and the valve body 20, 40, 50 are respectively provided in the first to third connector ports 14, 16, 19 of the connector 10 whose configuration is male type, and the pushers 32a, 34a, 36a are respectively formed in the inlet port 32, the outlet port 34 and the auxiliary outlet port 36 of the filter 30 whose shape is female type. To the contrary, it would be possible that a female type connector having a valve chamber and a valve body is used in combination with a male type filter having a pusher.

As set forth above, the water shut-off device of the present invention assures easier replacement of the filter, thank to the fact that the water flow is automatically cut off when the filter is removed from the connector, and the water flow is automatically resumed, when the filter is attached to the connector. Furthermore, the inventive water shut-off device helps reduce the manufacturing cost of a water purifier by making it possible to cut off the water flow in a simple and cost-effective manner without having to use a costly shut-off valve.

While this invention has been described in connection with what is presently considered to be the most practical and preferred embodiment, it is to be understood that the invention is not limited to the disclosed embodiment, but on the contrary, it is intended to cover various modification within the spirit and the scope of the appended claims.

1. A water shut-off device for a water purifier adapted to automatically cut off the flow of raw water at the time of replacing a filter, comprising:
a connector having a water inlet passageway and a first connector port in communication with the inlet passageway, said first connector port provided with a valve chamber; and
a valve body movably fitted into the valve chamber for closing the first connector port when the filter is detached from the connector and for opening the first connector port when the filter is attached to the connector.

2. The water shut-off device for a water purifier as recited in claim 1, wherein said filter has an inlet port connectable to the first connector port of the connector, a filter element, an outlet port, and a pusher for causing the valve body to move into a position in which the first connector port is opened, when the inlet port is brought into connection with the first connector port.

3. The water shut-off device for a water purifier as recited in claim 1, wherein said valve body comprises a ball adapted to close the first connector port by the pressure of the raw water introduced through the water inlet passageway.

4. The water shut-off device for a water purifier as recited in claim 1, wherein said valve body comprises a poppet adapted to close the first connector port by the pressure of the raw water introduced through the water inlet passageway, said poppet having a projecting rod contactable with the pusher through the inlet port of the filter.

5. The water shut-off device for a water purifier as recited in claim 1, wherein said connector is swingable about a pivot axis between a filter service position and a filter replacement position.

6. The water shut-off device for a water purifier as recited in claim 1, wherein said connector further has a second connector port connected to the outlet port of the filter and a purified water discharge passageway remaining in communication with the second connector port, said second connector port having a valve chamber in which a valve body is disposed for automatically closing the second connector port at the time of the filter being detached, said filter comprising a pusher for causing the valve body to move in a direction in which the second connector port is opened, when the inlet port is brought into connection with the second connector port.

7. The water shut-off device for a water purifier as recited in claim 1, wherein said connector further has a third connector port connected to the outlet port of the filter and an auxiliary discharge port remaining in communication with the third connector port, said third connector port having a valve chamber in which a valve body is disposed for opening and closing the third connector port, said filter comprising a pusher for causing the valve body to move in a direction in which the third connector port is opened, when the auxiliary discharge port is brought into connection with the third connector port.

8. The water shut-off device for a water purifier as recited in claim 1, further comprising a retainer removably attached to the first port of the connector for keeping the valve body in the valve chamber.

9. A water shut-off device for a water purifier adapted to automatically cut off the water flow at the time of filter replacement, comprising:
a connector having a water inlet passageway and a first connector port in communication with the inlet passageway, the first connector port provided with a valve chamber;
a valve body movably fitted into the valve chamber for closing the first connector port as the filter is removed from the connector and for opening the first connector port as the filter is attached to the connector; and
a filter means detachably attached to the connector, said filter means having an inlet port connectable to the first connector port of the connector, a filter element, an outlet port, and a pusher for causing the valve body to move into a position in which the first connector port is opened, when the inlet port is brought into connection with the first connector port.
